(19) United States
(12) Patent Application Publication
(10) Pub. No.: US 2008/0150431 A1
(43) Pub. Date: Jun. 26, 2008

(54) ULTRA HIGH PRESSURE MERCURY ARC LAMP

(75) Inventor: Barry Preston, Melton Mowbray (GB)

Correspondence Address: FAY SHARPE LLP, 1100 SUPERIOR AVENUE, SEVENTH FLOOR, CLEVELAND, OH, 44114, US

(73) Assignee: General Electric Company

(21) Appl. No.: 11/960,337

(22) Filed: Dec. 19, 2007

(30) Foreign Application Priority Data
Dec. 21, 2006 (GB) 0625609.3

(51) Int. Cl. H01J 17/04

(52) U.S. Cl. 313/631

(57) ABSTRACT

A high pressure arc discharge lamp apparatus comprises a lamp and operating means therefor, the lamp comprising an envelope containing a dose of mercury and a pair of electrodes with their tips (32, 34) spaced apart from one another to define an arc gap. At least one of the electrode tips is formed with a hollow (44, 46) in its surface (40, 42) facing the other electrode, and the operating means includes means for driving the lamp at an A.C. frequency of at least 200 Hz.

### BACKGROUND OF THE INVENTION

This invention relates to an ultra high pressure (UHP) mercury arc lamp. Such a lamp is particularly, although not exclusively, useful as a light source for an image projection apparatus.

For use in an image projection apparatus such as a liquid crystal projector, the ideal lamp has a light source which is as close as possible to being a point source, as well as being of high intensity. An ultra high pressure mercury arc lamp comes close to meeting this need, especially when the arc gap is very short, preferably less than about 1.5 mm.

In a typical ultra high pressure mercury arc lamp, a generally spherical quartz envelope forms the arc discharge chamber and contains the spaced-apart tungsten electrodes defining a discharge path, the electrodes being connected to current conductors which extend from the lamp to the exterior. The discharge chamber also contains an inert gas such as argon at a pressure on the order of 10-100 kPa; 10⁻¹²-10⁻⁸ moles per cubic millimeter of halogen (chlorine, bromine or iodine); and a dose of mercury of at least 0.15 mg per cubic millimeter. A lamp of this kind is described in EP-A-1,160,836. During operation of the lamp, the mercury is vaporized, with a typical vapor pressure of 15 to 25 MPa.

Current electrode structures limit the life of UHP mercury lamps to <20,000 hours. Protrusions grow naturally at the electrode tips during the first few hundred hours of operation, but are then continually eroded. This increase in arc gap between the electrodes beyond the original gap results in an increase in lamp voltage and a reduction in collected lumens from the arc tube reflector module. In times less than 20,000 hours the arc gap is doubled, reducing the collected light output to around or less than, half the initial output. This creates a technical lamp failure.

Currently all known UHP mercury lamps used for data and image projection employ a thick walled fused silica (quartz) burner. The arc burns between tungsten electrodes spaced roughly 1.0 mm apart. The burner is charged with mercury, the discharge medium, and a low pressure of the inert gas argon, which functions as the medium to start the discharge. Small quantities of bromine and oxygen are also included. These function to remove tungsten, evaporated from the electrode system from the wall back to the electrode structure. This maintains the transmission of the wall and hence the screen illumination. The electrodes, which are of tungsten, have generally rounded tips facing each other across the arc gap, and a wire coil may be wound around each electrode on the outboard side of each tip to improve cooling. In operation at low frequencies (<200 Hz) temporal fluctuations in electrode temperature promote the growth of single, so called tip protrusions. Above this frequency multiple tip protrusions are produced (26.2 Controlled Electrodes in UHP Lamps, SID Digest, 2004). Two major drawbacks of this electrode exist. At frequencies above 200 Hz the arc can jump between the protrusions, causing significant changes to screen illumination which cannot be eliminated by projector integrating optics. Below 200 Hz, as the protrusion erodes through the life of the lamp, ‘arc jumping’ across the surface also creates instabilities in screen illumination which is a major cause of end user dissatisfaction. One manufacturer has devised an operating strategy for promoting protrusion growth, which also tries to ensure that arc jumps do not take place. (26.2 Controlled Electrodes in UHP Lamps SID Digest, 2004; and 9.1 Arc Stabilisation for Short Arc Projection Lamps, SID Digest 2000.) This strategy is only partially successful. The second major drawback is that after a few hundred hours of operation first the protrusion and then the electrode tip are eroded by arc operation. This erosion results in an increasing physical length of the arc gap. This has two extremely important consequences for the performance of the lamp during its operational lifetime. First the lamp voltage increases. This reduces the lamp current since the electronic driver attempts to supply constant power to the lamp. This lower current reduces any tendency for protrusion growth. The increasing length of the arc gap increases the lamp voltage drop. When the voltage reaches a value around 155V, in current systems, the lamp driver switches the lamp off. By 155V the arc gap is virtually double its initial value. This increase in optical extent of the light source results in a dramatic reduction in the useful light collected by the lamp's integral reflector. Doubling the arc gap results in a reduction of useful light collected by about one half. At this point the light source is technically regarded as a failed device. The diameter of protrusions grown at electrode tips is only dependent on the frequency of operation of the lamp driver. The lowest possible frequency of operation is 90 Hz; this avoids flicker effects in projected images. At a constant initial lamp voltage (typically 85V) the load to the electrode protrusion and thus its rate of erosion depends on lamp power. Erosion increases with total lamp power. The longest surviving UHP lamp known survives for approximately 14,000 hours at an input power of 100 watts. For use in data projection and rear projection TV applications lamp powers of 120 Watts and above are desirable. The life of these lamps will be monotonically decreasing as a function of the input power. Published data (26.2 Controlled Electrodes in UHP Lamps SID Digest, 2004) suggests that a 150 W lamp will have a life of approximately 6000 hours only. In rear projection television applications lives greater than 20,000 hours are highly desirable.

All previous attempts at managing the issues of the electrode performance in current UHP lamps are based on initially promoting protrusion growth by optimization of the current waveform supplied by the lamp driver. These AC UHP lamps are always operated on a basic square wave current at low frequency, usually less than 120 Hz. This ensures the maximum protrusion diameter and thus the most robust protrusion to resist erosion. A current pulse introduced at the end of each current half cycle promotes protrusion growth. Examples of this approach are described in U.S. Pat. No. 5,608,294 and EP-A-1,389,036. The precise mechanism of protrusion growth is in dispute. In the publication 26.2 Controlled Electrodes in UHP Lamps SID Digest, 2004 it is suggested that the protrusion grows as a consequence of ion implantation into the electrode on the cathode half cycle. This view is almost certainly incorrect. It has now been shown experimentally that a protrusion can be grown on an anode. This would not be possible under an ion implantation model. It is theorized that the protrusion growth is the result of electrode temperature changes taking place in an atmosphere of tungsten vapor. During the switch between a cathode and anode half cycle the electrode protrusion temperature drops leaving the electrode tip in a supersaturated atmosphere of tungsten. Under these conditions the tungsten vapor condenses to form a protrusion. Using this model it has been possible to explain the protrusion diameter dependence on frequency and other features of the protrusion. For both models, what remains unexplained is why initially a protrusion is built but in subsequent life it only erodes. It has been suggested that it is possible to use the driver waveform to rebuild electrode protrusions at any time during lamp life. This would require active feedback from the lamp to the driver to alter the driver current waveform (U.S. Pat. No. 6,232,725, U.S. Pat. No. 6,239,556). Drivers having this feature have not been found on the market. A presumption is that this level of control for a lot of lamps that will all behave somewhat differently has not been possible to engineer reliably. In any case this approach increases the complexity of the ballast. Further literature has suggested that the initial growth of the electrode protrusions is important (U.S. Pat. No. 6,586,892) in the subsequent life of the lamp while other published information contradicts this view (26.2 Controlled Electrodes in UHP Lamps SID Digest, 2004).

### BRIEF DESCRIPTION OF THE INVENTION

The current application discloses a protrusion free electrode structure, which operates in a stable manner eliminating arc ‘jumps’. This disclosure describes an electrode structure that dramatically reduces or eliminates arc gap erosion which in turn leads to longer life devices. The disclosure is aimed at achieving lamp lives greater than 20,000 hours independent of lamp input power. The present invention also simplifies the driver function.

There is provided a high pressure arc discharge lamp apparatus comprising a lamp and operating means therefor, the lamp comprising an envelope containing a dose of mercury and a pair of electrodes with their tips spaced apart from one another to define an arc gap, at least one of the electrode tips is formed with a hollow facing the other electrode, and the operating means includes means for driving the lamp at an A.C. frequency of at least 200 Hz.

Preferably, the operating means includes means for driving the lamp at an A.C. frequency of at least 300 Hz. The hollow may be substantially cylindrical, and may be 0.5 mm to 2.5 mm deep, with a diameter of 230-350 μm. Both of the electrode tips may be formed with a hollow, whereby in operation of the lamp during successive half cycles of the A.C. waveform each hollow in turn acts as the cathode, with the rest of the other electrode tip acting as the anode.

The present disclosure combines the use of a hollow cathode with an increase in lamp driver frequency. The hollow cathode is preferably a cylindrical cavity in the tip of the electrode. In a hollow cathode the arc termination is diffuse rather than spot mode and thus the temperature of the electrode tip, the current density and the heat load at any point on the cathode surface are all much reduced in comparison with the spot mode operation of the protrusion electrode.

Still other benefits and advantages of the disclosure will become apparent from reading and understanding the following detailed description.

### BRIEF DESCRIPTION OF THE DRAWINGS

FIG. 1 is a cross-sectional view of a short arc mercury discharge lamp showing a typical electrode configuration.

FIG. 2 is an enlarged side elevation of the electrode tips of a lamp in accordance with the invention.

### DETAILED DESCRIPTION OF THE INVENTION

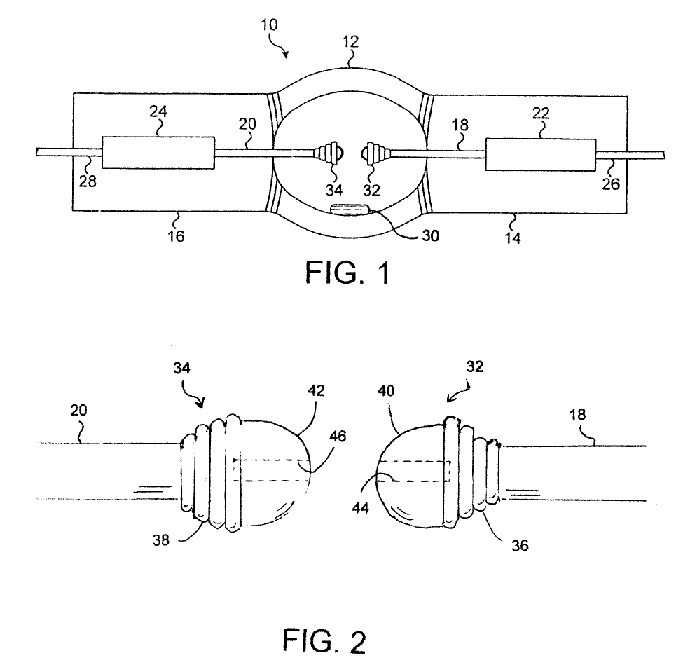

Referring to FIG. 1, a short arc mercury discharge lamp of known kind comprises a quartz envelope 10 which has a generally spherical central discharge chamber 12. Sealing arms 14, 16 extend from opposite sides of the discharge chamber 12, sealing the chamber 12. The arms 14, 16 also contain and support electrodes 18, 20, as well as metal foil connectors 22, 24 and lead-in wires 26, 28. The discharge chamber 12 contains a rare gas such as argon, at a pressure of the order of 10⁴-10⁵ Pa at room temperature, a small amount (10⁻¹³-10⁻⁸ moles per cubic millimeter) of a halogen, and a dose 30, of at least 0.15 mg per cubic millimeter, of mercury. Typically, the halogen may be bromine at a density of 10⁻¹²-10⁻⁹ moles per cubic millimeter. The electrode tips 32, 34 are spaced about 1 mm apart, and a wire coil may be wound around each electrode tip to improve cooling of the electrodes. The electrode tips are of a suitable refractory metal, such as tungsten, tantalum or molybdenum. In operation of the lamp, an electrical supply is connected through the lead-in wires 26, 28, the foil connectors 22, 24 and the electrodes 18, 20 to establish an electrical potential difference between the electrode tips 32, 34.

Referring also now to FIG. 2, the facing surfaces 40, 42 of the electrode tips may be of generally hemispherical shape, and at least one of them has a hollow 44, 46 formed generally axially of its electrode tip. Each hollow extends from the facing surface 40, 42 of its electrode tip into the body of the tip. The hollow may be of any shape, but preferably has a circular opening in the facing surface of its electrode tip. Suitable shapes are cylindrical, part-spherical, for example hemispherical, conical, frustoconical, a conic section rotated about the axis of the electrode, or a combination of these shapes. An example of such a combination is a hollow having a cylindrical portion adjacent the opening with a part-spherical or conical end within the electrode tip. The hollow in the electrode of a typical arc tube is preferably from 230-350 μm in diameter, with a depth of 0.5 mm-2.5 mm. In one example, the lamp apparatus includes a 120 W arc tube using a conventional tungsten electrode with a 290 μm diameter hole approximately 2 mm deep machined into the front face of the electrode tip. The hole may be formed using, for example, laser ablation or EDM.

By providing a cylindrical cavity in the tip of the electrode, when that tip is acting as the cathode, the arc termination is diffuse rather than spot mode and thus the temperature of the electrode tip, the current density and the heat load at any point on the cathode surface are all much reduced in comparison with the spot mode operation of the protrusion electrode. The anode, constituted by the remaining surface area of the other electrode tip, only functions as an electron collector. The surface area of the structure, which dissipates the electron energy, determines the temperature. With a standard cathode the protrusion and tip function, on successive half cycles of the applied A.C. voltage, as both cathode and anode. In the hollow cathode electrode, the hole functions as the cathode while the material surface functions as the anode. In this way some separation of the two functions is possible. It appears that with a standard electrode configuration, it is temporal temperature changes which drive the protrusion growth. By increasing the operating frequency (it must remain below the onset of acoustic resonance) this temporal temperature variation is drastically reduced. Since protrusion growth is dramatically reduced or eliminated by the use of a hollow electrode and higher frequency of operation, the arc terminations are now diffuse rather than spot terminations, so that erosion is much reduced. Thus the arc gap remains essentially constant leading to stable light output as a function of time. Because of the diffuse termination in the cathode half cycle with the termination location determined by the hole in the electrode and the diffuse nature of the termination of the anode half cycle the lamp will operate in a stable manner so that abrupt changes in screen illumination or flicker will not occur, and hence a more stable light output will be observed by end users. Only the required operating current determines the hole size. The global electrode temperature is determined by the surface area of the front face of the electrode, the electrode total surface area and the conduction path into the arc tube seal region, which accommodates the electrical feed through. The hole diameter is proportional to the square root of the lamp current. The driver square wave operating frequency should be set to be at least 200 Hz, preferably at least 300 Hz.

The advantage of this approach is to extend the life of the arc tube reflector module beyond that of currently available technology. The light output will be more stable and predictable throughout the lamp's life. The lamp of the present disclosure removes the electrode life dependency on lamp power permitting the long life to be achieved at optimal lamp light output and power. The lamp failure mode will be transferred from being the electrode system to some other mechanism in the lamp. On currently available information, with proper thermal design this is expected to be greater than 20,000 hours. The invention will dramatically reduce/eliminate observed screen flicker or illumination disturbances, while permitting the use of simpler cheaper lamp drivers. Other major advantages of this invention are that lower temperature electrodes (hollow cathode electrodes) will permit a lower bromine dose than that typically used in these lamps to ensure a clean wall. The resulting stable arc gap will also permit the design of lamps with arc gaps of less than 1.0 mm. This would lower the optical extent of the light source (etendue) and provide better optical coupling to smaller area light valves.

Various preferred embodiments have been described. Obviously, modifications and alterations will occur to others upon reading and understanding the preceding detailed description. It is intended that the disclosure be construed as including all such modifications and alterations.

1. A high pressure arc discharge lamp apparatus comprising a lamp and operating means therefor, the lamp comprising an envelope containing a dose of mercury and a pair of electrodes with their tips spaced apart from one another to define an arc gap, at least one of the electrode tips being formed with a hollow facing the other electrode, and the operating means includes means for driving the lamp at an A.C. frequency of at least 200 Hz.

2. The lamp apparatus of claim 1 wherein the operating means includes means for driving the lamp at an A.C. frequency of at least 300 Hz.

3. The lamp apparatus of claim 2 wherein the hollow has a substantially circular opening in the surface of the electrode tip.

4. The lamp apparatus of claim 3 wherein the hollow is substantially cylindrical.

5. The lamp apparatus of claim 4 wherein the hollow has a diameter of 230-350 μm and a depth of 0.5-2.5 mm.

6. The lamp apparatus of claim 3 wherein the hollow has a diameter of 230-350 μm and a depth of 0.5-2.5 mm.

7. The lamp apparatus of claim 2 wherein the hollow is substantially cylindrical.

8. The lamp apparatus of claim 1 wherein the hollow has a substantially circular opening in the surface of the electrode tip.

9. The lamp apparatus of claim 1 wherein the hollow is substantially cylindrical.

10. The lamp apparatus of claim 1 wherein each of the electrode tips is formed with a hollow, whereby in operation of the lamp during successive half cycles of the A.C. waveform each hollow in turn acts as the cathode, with the rest of the other electrode tip acting as the anode.
